(19) United States
(12) Patent Application Publication
(10) Pub. No.: US 2007/0056172 A1
(43) Pub. Date: Mar. 15, 2007

(54) Insolation Survey Device

(75) Inventors: Brian Thomas Wiley, Shokan, NY (US); Palvin Chee Leong Chan, Rhinebeck, NY (US)

Correspondence Address: WILEY ELECTRONICS, 1131 OLD KINGS HIGHWAY, SAUGERTIES, NY, 12477, US

(73) Assignee: WILEY ELECTRONICS LLC, Shokan, NY (US)

(21) Appl. No.: 11/162,521

(22) Filed: Sep. 13, 2005

(51) Int. Cl. G01C 17/34

(52) U.S. Cl. 33/268

(57) ABSTRACT

An insolation survey device consisting of a panoramic head mounted on an additional rotational stage. In operation, the entire assembly can be leveled. The additional rotational stage then allows the panoramic head to be aligned to north without affecting the level. The panoramic head accepts a digital camera as attachment. Pictures taken at intervals can be combined into a panorama and analyzed for shading factor.

### CROSS-REFERENCE TO RELATED APPLICATIONS

Not Applicable

### FEDERALLY SPONSORED RESEARCH

Not Applicable

### REFERENCE TO SEQUENCE LISTING

Not Applicable

### BACKGROUND OF THE INVENTION

A solar power system requires direct illumination by the sun. Surrounding vegetation and structures, which shade the system, will reduce the total amount of energy which can be captured. Before installing a system it is useful to quantify the effect of such shading.

The earliest survey methods use mechanical devices. U.S. Pat. No. 4,177,566 is a reflective assembly, which allows one to view the surroundings. A built-in level and compass allows one to orient the view with respect to north and hence to the path of the sun. A transparent overlay with lines indicating the path of the sun throughout the year shows where the sun will intersect the surroundings to produce shade. The surroundings may also be sketched onto the overlay to make a permanent record. Grid markings on the overlay allow one to calculate the duration of the shading. By summing the duration of shading and comparing to the duration of the day—which changes throughout the year—one may compute the fraction of shading throughout the year. There are several problems with this system. The transparent overlay must be made specifically for each latitude of interest; therefore, the solar installer must keep a large supply of different overlays or must use a nearby latitude to approximate the actual latitude. Since the system requires close interaction in the sketching process, it is difficult to use when in a precarious position, such as on a steep roof. The calculations are relatively inaccurate due to the coarse gridlines. Even so, the calculations required are laborious, time consuming, and prone to error.

U.S. Pat. No. 4,302,088 is a specialized camera, which generates a similar record photographically. A pinhole aperture allows a wide field of view. A transparent overlay with lines again shows where the sun will intersect the surroundings to produce shade. This method obviates the need for sketching, but is subject to all of the other problems previously listed.

A more modern method, as described by Tianxing and Wei, uses a digital camera with a fish-eye lens to capture a wide field of view image. The image is then displayed on a computer screen. The computer also calculates the path of the sun for the given latitude and overlays it on the display. Although the authors have not done so, it would be straightforward to calculate a shading fraction automatically. This would remove the time and effort of the previous methods. The problem with this method is that only very expensive digital cameras can accept a fish-eye lens. The fish-eye lens itself is also very expensive. The digital camera can be mounted on a tripod to take the picture. Although most tripods have a built-in level, they do not have provision to attach a compass and so may not be positioned accurately to north. The fish-eye picture is also undesirable because of its distorted view.

An alternative use of a digital camera would be to take a number of pictures, which cover the area of interest and assemble them into a panoramic view. There are a number of manufacturers who sell panoramic heads for this purpose The most general type is a spherical panorama head where the term spherical refers to the fact that the head can be positioned to point in any direction on an imaginary sphere which surrounds the camera. The spherical panoramic head generally mounts to a tripod and also has a screw to attach a digital camera. The head allows rotation of the camera up and down with respect to the horizon and has markings to show the resulting angle. It also allows rotation about the vertical so that 360 degrees of azimuth rotation can be covered. This angle is also generally marked so that regular intervals of rotation can be achieved. To assemble the best composite picture, these rotations must be done about the focal point of the camera. Since there is no standard attachment point for cameras with respect to the focal point, these heads generally have provision to adjust in three directions so that the focal point is properly positioned. One could use a spherical panoramic head to take a series of pictures from east to west at a horizontal rotation, which includes the local skyline. These could then be assembled into a panoramic view over which the path of the sun can be laid in order to analyze the shading fraction.

The problem is that it is difficult to both level the tripod and orient it to north at the same time while keeping the head at a zero azimuth rotation. The assembly has to be leveled, then adjusted to north, then the process repeated some number of times until its level and north orientation are both acceptable. An additional problem is that one must manually position a separate compass to the tripod and head. If one only levels the tripod, one could use the panoramic head to align to north and note the angle reading on the panoramic head. To take pictures from east to west, one would have to rotate from the initial north reading. Since the north position is most likely at an odd number, one is likely to make a mistake in setting the head from one position to the next. Also most heads have a limited resolution in angular measurement so that some inaccuracy will occur.

Accordingly, several objects and advantages of the present invention are:
(1) that it uses an inexpensive digital camera;
(2) that it provides an undistorted pictorial record of the survey;
(3) that it incorporates a bubble level and compass to allow rapid leveling and alignment to north;
(4) that it incorporates a separate adjustment stage to allow level and north to be separately aligned;
(5) that it allows easy positioning for taking a series of pictures which can be assembled into a panorama by computer;
(6) that it records the survey in digital format so that a shading fraction can be calculated by computer.

Still further objects and advantages will become apparent from a consideration of the ensuing description and drawings.

### BRIEF SUMMARY OF THE INVENTION

The present invention is a machine for accurately positioning an inexpensive digital camera with respect to level and north. The invention also provides for the camera to be tilted at an angle with respect to the horizon so that the picture will include the skyline. The invention also allows the camera to be rotated from east to west. By taking pictures at discrete intervals from east to west the entire skyline can be recorded. Since the record is in digital format, it can be transferred to a computer where the individual pictures may be assembled into a panorama of the skyline. By overlaying the path of the sun on the panorama, the computer can calculate a shading fraction for the site.

### BRIEF DESCRIPTION OF DRAWINGS

FIG. 1 shows the invention completely assembled.

FIG. 2 shows the invention in exploded view.

FIG. 3 shows the rotated upper portion of the invention in exploded view.

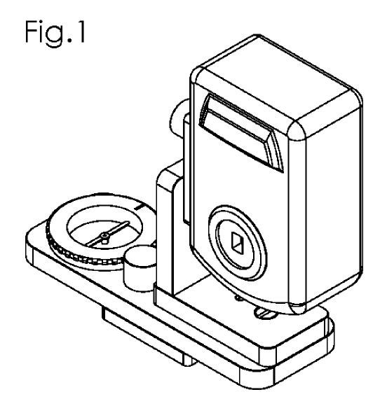

### DETAILED DESCRIPTION—FIGS. 1 through 3

One may consider the invention to consist of a panoramic head rigidly mounted to a north positioning stage. The panoramic head in turn consists of a horizontal tilting stage mounted atop a panoramic positioning stage.

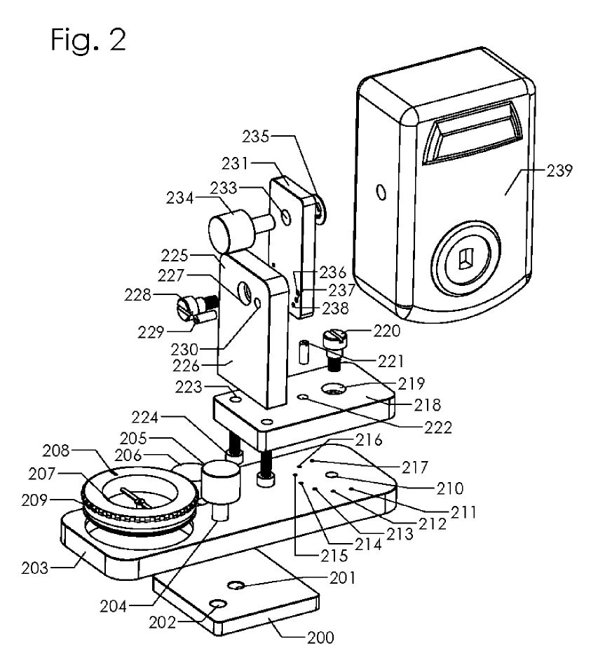

The north positioning stage will be described first. As illustrated in FIG. 2 of the drawings, a mounting plate 200 has a ¼-20 threaded hole 201 suitable for attaching to a tripod. A north positioning plate 203 has a through hole 204. A north locking screw 205 protrudes through plate 203 and screws into a threaded hole 202 in mounting plate 200. When north locking screw 205 is loosely screwed in, north positioning plate 203 is free to rotate. When north locking screw 205 is firmly screwed in, north positioning plate 203 is fixed in position. North locking screw 205 is knurled for a firm grip. Alternatively, a thumb screw or any form of quick release locking mechanism could be used. It should be apparent to one skilled in the art that north locking screw 205 also functions as a crude kind of bearing and that a sleeve, ball or other form of bearing could also be used. It should also be noted that the mounting plate 200 need not be rectangular. In particular a circular plate may be easier to use with a bearing.

North positioning plate 203 contains a bulls eye type bubble level 206. Alternatively, two linear levels at right angles to each other could be used. North positioning plate 203 also contains a compass 207, which has a north indicating mark 208 and a declination adjustment dial 209.

The panoramic positioning stage is described as follows. A panorama positioning plate 218 has a counter bored hole 219 through which shoulder screw 220 screws into threaded hole 210 in north positioning plate 203. A ball plunger 221 screws into a threaded hole 222. When fully screwed in, shoulder screw 220 holds panorama positioning plate 218 snugly against north positioning plate 203. Shoulder screw 220 also provides a bearing surface for panorama positioning plate 218 to rotate. A sleeve or ball bearing could also be used, but at increased cost. When ball plunger 215 lines up with a detent hole 211, panorama positioning plate 218 will tend to stay at that rotation position. Detent holes 211-217 are arranged so that the camera will face at angles 90 degrees (East), 120 degrees, 150 degrees, 180 degrees (South), 210 degrees, 240 degrees, and 270 degrees (West) when ball plunger 215 lines up with them. More or less detent holes could be used, depending on the field of view of the camera and the resolution of the survey desired. Detents at irregular intervals could also be used, which may simplify machining, but complicate subsequent processing of pictures. Alternatively, angles could be marked on the panorama positioning plate and the user could visually set the panorama positioning plate to the proper angular positions.

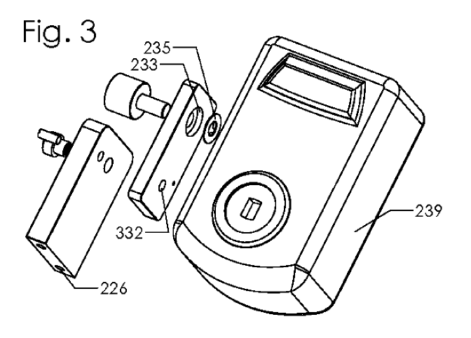

The horizontal tilting stage is described as follows. Panorama positioning plate 218 has through holes 223. Screws 224 screw into threaded holes 226 in a horizon positioning plate 225. Counter bored hole 227 accepts shoulder screw 228, which screws into a threaded hole 332 of FIG. 3 in camera mounting plate 231. A threaded hole 230 accepts a ball plunger 229. Counter bored hole 233 accepts camera mounting screw 234, which is held in place by a retaining clip 235. Digital camera 239 attaches to camera mounting screw 234. Shoulder screw 228 provides a bearing surface for camera mounting plate 231 to rotate. Detent holes 236-238 are arranged so that the camera will face at the horizon, 22.5 degrees up from the horizon, and 45 degrees up from the horizon. More or less holes could be used, depending on the field of view of the camera and the resolution of the survey desired. Detents at irregular intervals could also be used, which may simplify machining, but complicate subsequent processing of pictures. Alternatively, angles could be marked on the horizon positioning plate and the user could visually set the horizon positioning plate to the proper angular positions.

It should be apparent to one skilled in the art that the invention could also be constructed as a panoramic positioning stage mounted atop a horizontal tilting stage mounted atop a north positioning stage. In that case, the combination of horizontal tilting stage and panoramic positioning stage would still constitute a type of spherical panoramic head. The range of angles could also be restricted, such as by fixing the horizontal stage at a single angle.

The invention as detailed is only suitable for use with cameras having a specific geometry of mounting hole to focal point. It should be apparent that one could also construct the invention to be able to adjust in the x, y and z directions to accommodate various geometries of mounting hole to focal point.

### Operation—FIGS. 1 through 3

Referring to FIG. 2., ¼-20 threaded hole 201 in mounting plate 200 is suitable for attachment to a tripod. The tripod can be adjusted to level the invention by using bubble level 206. Alternatively, a lockable ball and socket joint could be used for leveling. Although a tripod is a commonly available and simple mount, it should be apparent that other mounting arrangements are possible, for instance, a monopod or a simple grip attachment for handheld use.

After slightly loosening north locking screw 205, the north positioning plate 203 and all attached pieces are free to rotate. Compass 207 indicates direction to magnetic north by its relative position with respect to north indicating mark 208. In order to obtain direction to true north, declination adjustment dial 209 may be adjusted for the actual latitude and longitude. Compass 207 then indicates direction to true north by its relative position with respect to the declination adjustment dial 209. North positioning plate 203 is rotated until it is aligned to true north, then north locking screw 205 is tightened to keep it in position. The panorama positioning stage and horizontal positioning stage are now level and aligned to north.

The horizontal positioning stage is adjusted next. Horizon positioning plate 231 and the attached digital camera 239 are rotated with respect to the horizon to an angle appropriate to capture the skyline where one of detents 236-238 line up with ball plunger 229. The panorama positioning stage is adjusted next. The panorama positioning plate 218 is first rotated to face east, where detent 211 lines up with ball plunger 221 and a picture is taken. Pictures are then taken at successive detent positions, until the panorama positioning plate 218 faces west, where detent 217 lines up with ball plunger 221. The panorama positioning and picture taking may be repeated for additional horizontal positioning angles, as desired for overall picture effect and resolution.

All pictures can then be transferred to a computer where they can be assembled into a panorama and analyzed for shading factor.

What is claimed is:

1. An insolation survey device, comprising:
a) a mounting plate,
b) a north positioning plate,
c) a locking means, said locking means when in the loosened state allowing said north positioning plate to move with respect to said mounting plate and when in the tightened state restraining north positioning plate from being able to move with respect to said mounting plate,
d) a panoramic head, said panoramic head rigidly fixed to said north positioning plate, said panoramic head capable of attaching a digital camera,
whereby said locking means may be loosened, said panoramic head positioned as desired, and said locking means tightened to keep said panoramic head in position.

2. The insolation survey device of claim 1, additionally comprising:
e) a bubble level affixed to said north positioning plate, said bubble level indicating when said north position plate and said attached panoramic head are level,
whereby said north positioning plate and said attached panoramic head may be leveled, said locking means may be loosened, said panoramic head positioned as desired, and said locking means tightened to keep said panoramic head level and in position.

3. The insolation survey device of claim 1, additionally comprising:
e) a compass affixed to said north positioning plate, said compass indicating position of said north position plate and said attached panoramic head,
whereby said locking means may be loosened, said panoramic head positioned with respect to north as desired, and said locking means tightened to keep said panoramic head in position with respect to north.

4. The insolation survey device of claim 1, additionally comprising:
e) a bubble level affixed to said north positioning plate, said bubble level indicating when said north position plate and said attached panoramic head are level,
f) a compass affixed to said north positioning plate, said compass indicating position of said north position plate and said attached panoramic head,
whereby said north positioning plate and said attached panoramic head may be leveled, said locking means may be loosened, said panoramic head positioned with respect to north as desired, and said locking means tightened to keep said panoramic head level and in position with respect to north.
